(19) United States
(12) Patent Application Publication
(10) Pub. No.: US 2004/0003044 A1
(43) Pub. Date: Jan. 1, 2004

(54) Multi-channel media streaming and distribution system and associated methods

(76) Inventors: Gary Chee Wooi Teoh, Petaling Jaya (MY); Kok Kuan Chang, Bukit Jambul (MY)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/184,090

(22) Filed: Jun. 26, 2002

(51) Int. Cl. G06F 15/16; H04Q 11/00

(52) U.S. Cl. 709/205; 370/270

(57) ABSTRACT

A multi-channel media streaming and distribution system and associated methods is introduced.

### TECHNICAL FIELD

The invention generally relates to the field of electronic collaboration systems and, more particularly to a multi-channel media streaming and distribution system and associated methods.

### BACKGROUND

Recent developments in the technology of data networks and general purpose computing systems have enabled a new class of applications colloquially referred to as electronic collaboration tools. In an electronic collaboration environment such as an electronic classroom, electronic meeting space, etc., computing systems enabled with electronic collaboration tools are coupled together through one or more data networks to facilitate an exchange of information.

Traditional electronic collaboration tools supported text messaging, e.g., electronic mail or instant messaging communication tools. With advancements in technology, electronic collaboration tools are beginning to introduce limited multi-media (e.g., audio and video) communication resources to the toolset.

The multimedia communication resources are limited in the sense that conventional collaboration tools only support a single, common media channel shared among all participants in the collaboration environment. That is, conventional collaboration tools merely support a single, broadcast channel where the information (audio/video) transmitted via the media channel are displayed or heard by all participants of the collaboration environment.

Another limitation commonly associated with conventional collaboration tools is that often the control, or management of the broadcast media channel is assigned to a designated management station (e.g., a teacher station in an electronic classroom environment), and the management station is the only station that can stream media content to the other participants (e.g., the students, or a select subset thereof). Allocation of the media channel to another participant requires the authorization of the participant controlling the management station.

Often, it would be desirable to set-up a disparate channel between just a subset of such users in the collaboration environment to facilitate dedicated delivery of media content between such users. While conventional collaboration tools may permit an email communication path, or an instant messaging communication path between a subset of users of a collaboration environment, such conventional systems do not provide a user with a means to establish independent media channels between select users of a collaboration environment.

What is required is an electronic collaboration tool that enables substantially real-time communication of media content between select users within a broader collaboration environment.

### BRIEF DESCRIPTION OF THE DRAWINGS

Embodiments of the invention are best understood by way of example, and not by way of limitation, in the figures of the accompanying drawings in which like reference numerals refer to similar elements and in which:

FIG. 1 is a block diagram of an example network in which one example implementation of an embodiment of the invention may be practiced;

FIG. 2 is a block diagram of an example media streaming module, suitable for use in a broad range of computing appliances, according to one example embodiment of the invention;

FIG. 3 is a block diagram illustrating an example data structure used by the media streaming module in accordance with one embodiment of the invention;

FIG. 4 is an illustration of an example datagram used in accordance with one embodiment of the invention;

FIG. 5 is a flowchart of an example method for controlling an electronic collaboration environment in accordance with one embodiment of the invention;

FIG. 6 is a flowchart of an example method for media capture according to one embodiment of the invention;

FIG. 7 is a flowchart of an example method for media playback according to one embodiment of the invention;

FIG. 8 is a flowchart of an example method for media filtering according to one embodiment of the invention;

FIG. 9 is a graphical illustration of an electronic classroom collaboration environment incorporating the teachings of an embodiment of the invention;

FIG. 10 is a block diagram of an example computing appliance illustrating alternate embodiments of the invention; and

FIG. 11 illustrates a block diagram of an example storage medium comprising a plurality of executable instructions which, when implemented by an accessing computing system, implements the media streaming module in accordance with the teachings of the present invention.

### DETAILED DESCRIPTION

Embodiments of the invention are generally directed to a multi-channel media streaming and distribution system and related methods. In this regard, according to one example embodiment of the invention, a media streaming module (MSM) is introduced. The media streaming module enables substantially real-time (e.g., “live”), multi-group communication of multimedia content within an electronic collaboration environment. Implemented within computing appliances of an electronic collaboration environment, the media streaming module uses multiple identifiers to uniquely identify disparate groups, and individual computing appliances within such groups, in establishing virtual media streaming and distribution channels between select participants of the collaboration environment. According to one example embodiment, the media streaming module in each of the computing appliances establishes a separate receive buffer associated with each source of media content to maintain proper separation of content between groups and media channels.

To facilitate the proper routing of such content, media streaming module includes a media manager which dynamically generates packets of media content including one or more of source, target and channel information for transmission to select computing appliances within the collaboration environment. Based, at least in part, on at least a subset of such information, the received packets are placed in receive buffer associated with an identified “channel” for rendering to the collaboration participant. Although developed in the context of audio content, those skilled in the art will appreciate that embodiments of the invention are readily extensible to cover other media types, e.g., video content, textual content, and the like.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

Example Network Architecture

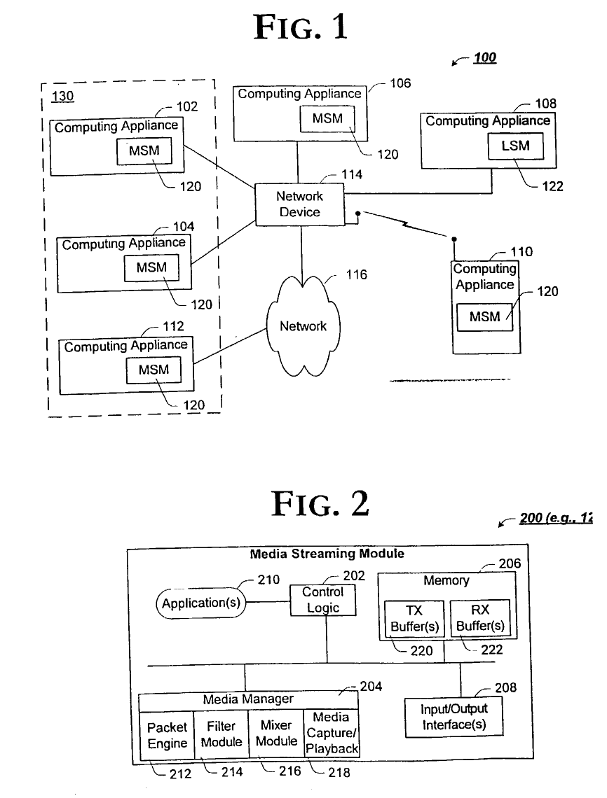

FIG. 1 is a block diagram of an example network architecture incorporating the teachings of an embodiment of the invention. As shown, network 100 is depicted comprising a plurality of computing appliances, or work stations, 102-112 communicatively coupled through a network device 114 to create an electronic collaboration environment. As used herein, network 100 may well represent a local area network (LAN), wide area network (WAN), metropolitan area network (MAN), the Internet, a communications network and the like. Indeed, 112 one or more of the computing appliances of the electronic collaboration environment, e.g., 112, may be coupled through elements of a second network 116, which may also be a LAN, WAN, MAN, communications network, etc.

In accordance with one aspect of the present invention, at least a subset of computing appliances 102-106, 110 and 112 are endowed with an innovative media streaming module (MSM) 120. As developed more fully below, computing appliances 102-106, 110 and 112 are endowed with electronic collaboration tools that leverage the media streaming and distribution features of MSM 120 to provide an enhanced electronic collaboration environment wherein multiple, independent media streaming and distribution channels are dynamically established, under participant control, to facilitate independent communication between select subsets of participants in the electronic collaboration environment.

According to one example implementation, network 100 is presented comprising two distinct media streaming and distribution channels, one channel supporting broadcast among all collaboration participants 102-112, and another channel 130 supporting independent communication between a select subset of participants, e.g., appliances 102, 104 and 112. According to one embodiment, participants using appliances 102, 104 and 112 may only utilize one communication channel at a time, i.e., they must either select the broadcast channel, or channel 130. As used herein, the electronic collaboration tools are intended to represent any of a wide variety of collaboration applications such as, e.g., electronic classroom applications, electronic conferencing applications, content development collaboration tools, and the like.

As shown, computing appliance 108 is populated with a legacy streaming module 122, representative of the prior art. In this regard, a participant using computing appliance 108 cannot establish a dedicated media streaming and distribution channel independent of the common broadcast channel used among all collaboration participants. Although legacy streaming module 122 does not support multiple independent media streaming and distribution channels, media streaming module 120 is still compatible with such legacy devices in providing traditional electronic collaboration communication resources, e.g., a broadcast media streaming and distribution channel.

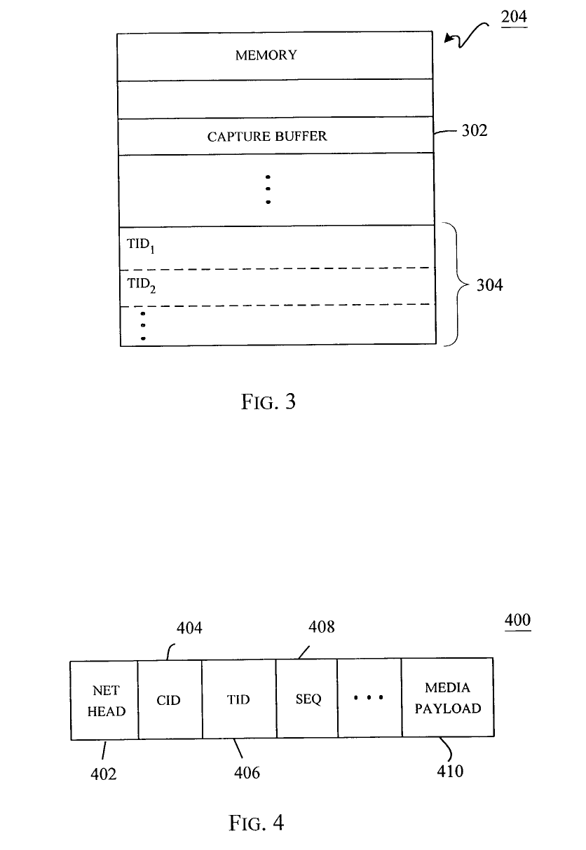

FIG. 2 is a block diagram of an example media streaming module, suitable for use in a broad range of computing appliances, according to one example embodiment of the invention. As shown, media streaming module (MSM) 200 is depicted comprising control logic 202, media manager 204, memory system 206, input/output interface(s) 208 and, optionally, applications 210, each coupled as shown. In accordance with one aspect of the invention, media manager 204 is depicted comprising packet engine(s) 212, filter module(s) 214, mixer module(s) 216 and media capture and playback module 218, each logically related as depicted. Memory system 206 is depicted including memory space for one or more transmit buffer(s) 220 as well as receive buffer(s) 222. According to one example implementation, media streaming module 200 may well be used in one or more computing appliances 102-106, 110 and 112 of collaboration environment 100 as MSM 120.

As used herein, control logic 202 controls an overall operation of the media streaming module 200. According to one aspect of the present invention, control logic 202 selectively invokes one or more features of media manager 204 to establish and control one or more media streaming and distribution channels between a host computing appliance and at least a subset of other computing appliances participating in an electronic collaboration environment.

In this regard, control logic 202 receives media control instruction(s) from, e.g., a collaboration tool executing on the host computing appliance to establish independent media streaming and distribution channels with identified participants of the collaboration environment. In addition, control logic 202 may well receive control instructions from remote computing appliances intending to establish an independent media streaming channel with the host computing appliance, to which control logic 202 selectively invokes one or more features of media manager 204 to support such communication.

As shown, media manager 204 includes a media capture and playback module 218. In capture mode, media capture and playback module 218 interfaces with media input resources (e.g., microphone, video source, etc.) of a host computing appliance to receive raw media content (e.g., pulse code modulated audio content). According to one example implementation, the raw media content is received into buffers, selectively accessed by media capture and playback module 218 for processing, before promoting the processed content to transmit buffer 220. More particularly, media capture and playback module 218 processes captured media content in accordance with any of a plurality of compressor/decompressor (CODEC) formats, e.g., the MP3 format introduced above.

According to one embodiment of the invention, media manager 204 is depicted comprising filter module 214. As used herein, filter module 214 selectively samples content received from the media capture device(s) of the host computing appliance (e.g., microphone, video camera, etc.) and analyzes the sampled content to determine if the content is merely noise.

According to one implementation, filter module 214 identifies noise in the captured media content by detecting if audio content, for example, exceeds a threshold level during a sample period (e.g., one (1) second) of content. In a video example, filter module 214 calculates the sum of absolute differences (SAD) of the content in successively sampled frames, and determines that the samples contain noise if the SAD exceeds a threshold (denoting noise).

According to one embodiment, if filter module 214 determines that the sampled content represents noise, the sampled content is disregarded and media capture and playback module 218 performs no additional processing on the content.

As used herein, packet engine 212 of media manager 204 packetizes and de-packetizes media content for transmission to remote computing appliances of the electronic collaboration environment. In support of transmit functions, packet engine 212 receives content from transmit buffer 220 and encapsulates the processed media content in a datagram to form a media packet. According to one example implementation, packet engine 212 assembles a media packet comprising a network header, a channel identifier, a source identifier and a media payload. The network header is selected based on a type of network supporting the collaboration environment. The channel identifier and source identifier are provided by control logic 202, and represent a media streaming and distribution channel assigned to the group in which the computing appliance is currently active. The media payload is the processed media content pulled from the transmit buffer 220.

In receive mode, packet engine 212 receives packets from one or more network interfaces and deconstructs the media packet to recover at least the source identifier, a sequence number and the media payload. This information is then provided to media capture and playback module 218 for playback processing.

In media playback mode, media capture and playback module 218 receives media content and source identifier information from packet engine 212. Media capture and playback module 218 processes the media payload to recover the media content, a sequence number if embedded within the media payload, and stores the recovered media content in a buffer associated with the identified source of the content. According to one embodiment, media capture and playback module 218 selects a decompressor that is compatible with the received format of the content, e.g., MP3. The decompressed media content is placed into a receive buffer(s) associated with the identified source of the media content in sequence based, at least in part on the sequence number.

Media manager 204 is also depicted comprising a mixing module 216. As used herein, mixing module 216 monitors the receive buffer(s) 222 of participants on the currently assigned channel of the host computing appliance. Whenever content is available in one or more of the receive buffers of participants on the currently assigned channel, mixing module 216 accesses and mixes such content for rendering by one or more output resources (e.g., speakers, display device, etc.) of the host computing appliance.

FIG. 3 is a block diagram illustrating an example data structure used by the media streaming module in accordance with one embodiment of the invention. As depicted, data structure 300 is presented comprising a number of disparate regions 302 . . . 304 to maintain one or more media capture buffer(s) 302 and one or more receive buffer(s) 304. As used herein, media capture buffers 302 are intended to represent buffer(s) 220 of MSM 200 that receive media content from the host computing system for transmission to collaboration partners, e.g., transmit buffer(s). Buffer(s) 304 are intended to represent receive buffers 222 of MSM 200, i.e., that receive content from collaboration partners the collaboration network.

According to one embodiment, i.e., wherein a computing appliance may only communicate along one selected media channel at a time, media manager 204 of MSM 200 need only establish a single capture buffer 302. As introduced, above, media capture buffer 302 receives media content from a media source (e.g., microphone) of the host computing appliance through the media capture and playback module 218. Other elements of media manager 204, e.g., packet engine 212, access the content from the capture buffer 302, process the received content to introduce one or more of source, target and channel information in accordance with the description to follow, and transmits the processed packets to at least select computing appliances of the collaboration environment. It is anticipated that multiple capture buffers may well be employed to facilitate simultaneous communication along multiple media channels within the teachings of the present invention.

According to one example implementation, the selection of the target(s) of the captured content is controlled by a host collaboration tool. In alternate embodiments, the selection is controlled by one or more of applications 210 of MSM 200 (e.g., a user interface), or a remote management computing appliance.

According to one example implementation, media streaming module 200 establishes a receive buffer 304 for each computing appliance 102-106, 110 and 112 participating in the collaboration environment. According to one example implementation, MSM 200 of a collaboration manager (106) informs each of the participants of each group established within the collaboration session of their group affiliations, communication parameters, and the like. Such control communications may well be performed using in-band or side-band communication channel(s). In this way, each MSM 200 of the collaboration partners establish receive buffers associated with each collaboration participant for each group. According to one implementation, introduced above, each source (talker) participant is uniquely denoted by a source identifier (SID), e.g., their internet protocol (IP) address, MAC address, etc. Alternatively, MSM 200 establishes a receive buffer associated with a source identified upon receiving the first packet of content from the source, thereby conserving memory resources until required.

Although depicted within a common memory structure 300, those skilled in the art will appreciate that data structures of greater or lesser complexity may well be employed within a single, or spread across multiple physical memory devices without deviating from the spirit and scope of the present invention. That is, the example implementation of FIG. 3 is intended to illustrate the teachings of the present invention, and not represent a limitation thereto.

Turning briefly to FIG. 4, an illustration of an example datagram used in accordance with one embodiment of the invention is presented. As shown, datagram 400 is depicted comprising one or more fields 402 . . . 410 including, for example, a network header field 402, a channel identifier field 404, a source (or, talker) identifier field 406, a packet sequence field 408, and a media payload field 410. It is to be appreciated that datagrams of greater or lesser complexity which facilitate the establishment of multiple, independent media streaming and distribution channels are anticipated within the scope and spirit of embodiments of the present invention.

The network header field 402 is generated by packet engine 212 and includes the information necessary to properly route the datagram through the one or more networks of the collaboration environment. In this regard, network header field 402 may well include the UDP, RTSP, or TCP information necessary to route the datagram through such network architectures.

The channel identifier field 404 denotes which channel of the multiple channels supported by the media streaming module 300 the datagram is destined. The source identifier field 406 denotes the source computing appliance of the media payload and, in this regard, may include a network address, a media access control (MAC) address of a network interface of the host computing appliance, a serial number of the computing appliance, some identifier associated with the MSM 300 implemented within the host computing appliance, and the like.

The sequence identifier field 408 denotes a sequence value of the packet. According to one example implementation, packet engine 212 assigns a sequence identifier to each packet to ensure that the content when received (perhaps, out of order), can be properly reordered so that the media payload is rendered (audio and/or video display) in the proper sequence. The media payload field 410 is populated with media content that has been processed in accordance with the compression/decompression (CODEC) scheme employed by elements of the collaboration environment. According to one implementation, the media content is compressed into an MPEG-1 Layer 3 format (MP3) (see, e.g., International Standards Organization standard ISO/IEC 1172-3:1993 entitled Coding of moving pictures and associated audio for digital storage media at up to about 1,5 Mbit/s—Part 3: Audio et al. (1993 and 1996)). It is to be appreciated, however, that any of a wide variety of CODECS may well be used within the spirit and scope of the present invention.

Example Operation and Implementation

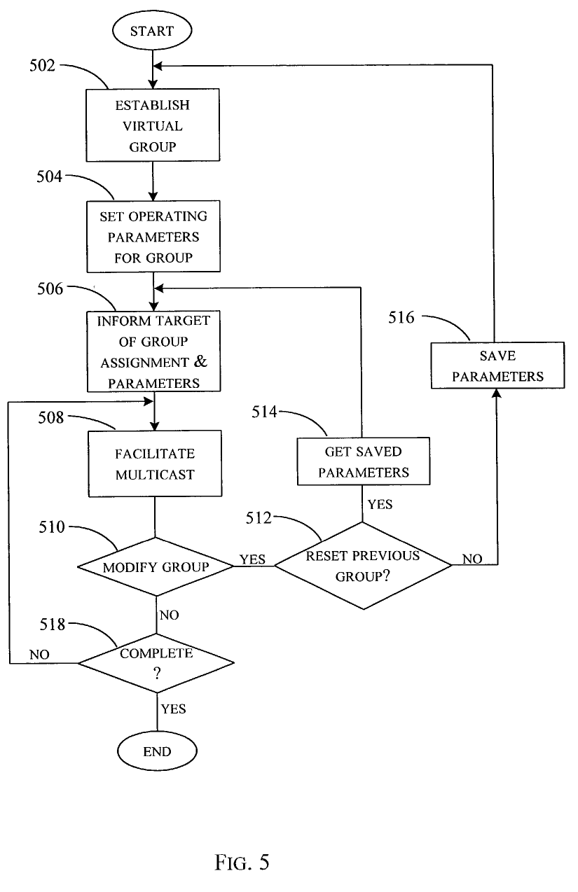

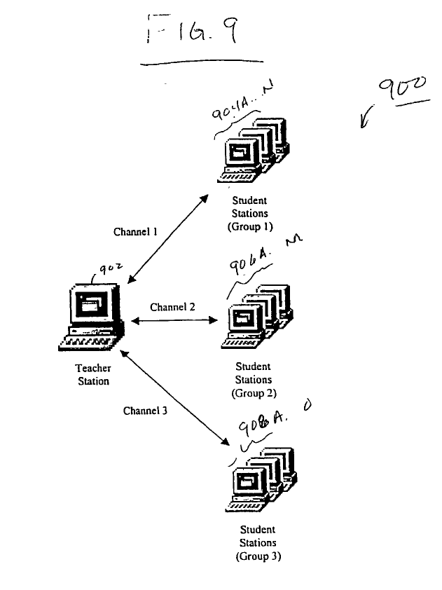

FIG. 5 is a flowchart of an example method for controlling an electronic collaboration environment in accordance with one embodiment of the invention. For ease of illustration, and not limitation, the teachings of the present invention will be developed more fully in the context of an electronic classroom collaboration environment, such as that graphically depicted in FIG. 9. In accordance with this example implementation, media streaming module 200 in a computing appliance assigned to a collaboration manager (e.g., an instructor) 106 controls the grouping of the other computing appliance(s) assigned to the other collaboration participants (e.g., students) 102-112. It should be appreciated, however, that the control and management features of MSM 200 invoked on the collaboration manager appliance may well be invoked on all participants stations in alternate embodiments, thereby enabling each of the participants an element of control over their collaboration groupings.

As shown, the method begins with block 502 where the MSM 200 in the collaboration manager 106 establishes one or more groups of collaboration participants within the electronic collaboration environment. According to one example implementation, one group includes all collaboration participants in a broadcast group, while one or more additional groups of select subsets of participants is established, each having a dedicated multicast media streaming and distribution channel. According to one embodiment, media streaming module 200 receives an indication from a host collaboration tool (e.g., an application executing on the host computing appliance, or one of applications 210) of the computing appliances to be assigned within each of the groups. According to one example implementation, media streaming module 200 includes a user interface (e.g., of applications 210) that enables the collaboration manager to establish such one or more groups.

In block 504, media streaming module 200 of the collaboration manager appliance 106 establishes the operational parameters for each of the one or more groups. More particularly, media streaming module 200 establishes a channel identifier for each of the established media streaming and distribution channels used for communication within such groups. Within the collaboration manager appliance 106, media capture and playback module 218 establishes one or more capture buffer(s) 302, and a receive buffer 304 associated with each of the other collaboration participants.

In block 506, the media streaming module 200 of the collaboration manager appliance 106 informs the target (student) computing appliances 102, 104, 108-112 of the grouping assignments and operating parameters.

Once the media streaming module 200 of computing appliances 102, 104, 110 and 112 receive the grouping and operating parameter information, the media streaming module 200 resident in such devices is configured to facilitate multicast communication through at least one of the channels associated with the at least one group to which the student appliance 102, 104, 108, or 112 belongs. As provided above, those appliances 102, 104, 110, 112 endowed with MSM 200 establish a capture buffer 302, and a number of receive buffer(s) 304, e.g., one for each collaboration participant within the groups to which the MSM 200 is assigned. In the legacy streaming module 122 of appliance 108, a single capture buffer and a single receive buffer is established associated with the broadcast channel of the collaboration environment.

According to one embodiment, computing appliances can only be active (i.e., communicate within) one group at a time. According to one embodiment, the collaboration manager through a host collaboration tool executing on computing appliance 106 controls the group in which each participant is active at any given point in time. In alternate embodiments, the student may control the group in which they are active. According to one embodiment, a media streaming module 200 employed in the collaboration manager appliance 106 may be active in multiple groups simultaneously, i.e., through the orchestrated use of multiple capture buffers and receive buffers.

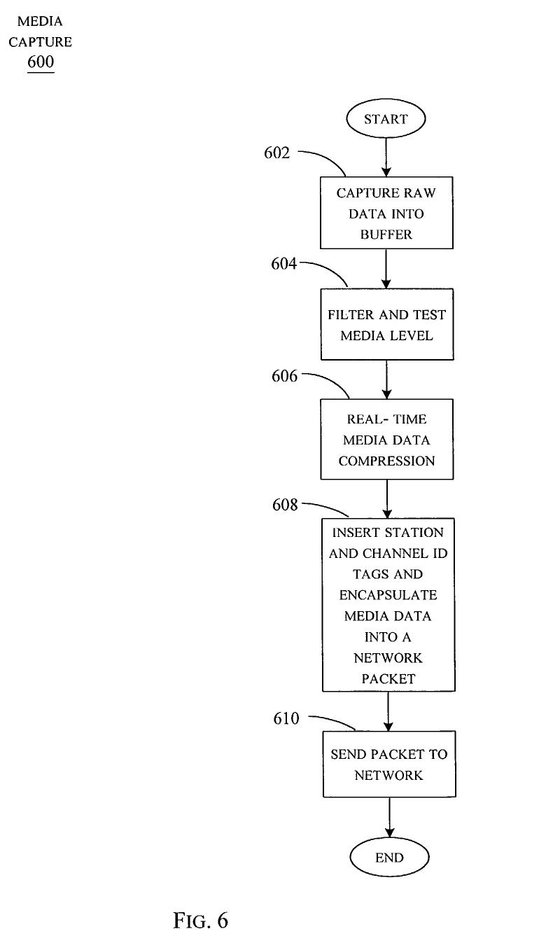

In block 508, media streaming module 200 in each of the computing appliances 102-106, 110, 112 facilitate multicast communication within the one or more groups. More particularly, the media streaming module 200 selectively performs the media capture and playback, mixing, filtering and packet generation features introduced above, and developed more fully below in FIGS. 6-8, in support of the multi-channel collaboration environment. In short, the collaboration manager 106 may communicate with the entire collaboration environment (broadcast channel), or established sub-groups by dynamically selecting the group (e.g., through a user interface) in which the collaboration manager is active. According to one embodiment, media streaming module 200 provides a user interface (210) through which such management occurs; alternatively, MSM 200 relies on an indication from a host collaboration tool as to the group in which the instructor wishes to participate. Such communication continues until MSM 200 of the collaboration agent 106 receives an indication to modify participant groupings, block 510, or the collaboration session is completed, block 518.

In block 510, media streaming module 200 of the collaboration manager appliance 106 determines whether an indication to modify one or more of the group(s) is received. Such an indication may be received from one or more of a host collaboration tool, a user interface, and/or a remote collaboration participant. If such an indication has been received, control logic 202 of media streaming module 200 determines whether the requested modification will require a new grouping. If not, the collaboration process continues with block 518.

In block 512, if a group is modified, control logic 202 of MSM 200 of the collaboration manager 106 determines whether the group is being modified with a previously registered participant of the group, or with a new participant. If the group is being modified with a previously registered (e.g., at initiation of the collaboration session) participant, control logic 202 recovers the operating parameters associated with the participant (e.g., source ID, etc.), block 514, and proceeds to inform the MSM 200 of computing appliances within the group of the addition of the participant, block 506.

If, in block 512, MSM 200 of the collaboration manager 106 determines that the participant is not a registered member of the group, or that a new group is being established, the process continues with block 516 wherein control logic 202 of the collaboration manager MSM 200 saves the operating parameters for the existing collaboration grouping, before continuing with block 502 to establish the new group. As used herein, a new MSM 200 of collaboration manager 106 establishes a group with new operating parameters if (1) a participant is being added to an existing grouping for the first time, or (2) when an entirely new group is being established. As a result, the process continues with block 502, as the control logic 202 of media streaming module 200 of the instructor computing appliance establishes the new group, sets the operating parameters (block 504), and informs the MSM 200 of the new group members of the operating parameters (block 506).

Although developed in accordance with an electronic classroom collaboration environment, those skilled in the art will appreciate that the media streaming module 200 may well be employed in alternative collaboration environments. In this regard, substituting the term manager” for “instructor” and “client” for “student” may translate the embodiment of FIG. 5 to a corporate collaboration environment. Moreover, as introduced above, the management and control features discussed with reference to the MSM 200 implemented on an instructor computing appliance may well be invoked on any or all of the computing appliances within the electronic collaboration environment without deviating from the spirit and scope of the present invention. Thus, the labels “manager” and “client” are temporally constrained in that an computing appliance may, at one time, be a manager while acting as a client at another time. Similarly, a computing appliance may well be acting as a manager with respect to one group, while simultaneously acting as a client with respect to another group without deviating from the spirit and scope of the present invention.

FIG. 6 is a flowchart of an example method for media capture according to one embodiment of the invention. As introduced above, control logic 202 of MSM 200 invokes an instance of media capture and playback module 218 for media capture operations. As used herein, the media capture process begins with block 602, wherein module 218 captures raw media data into a buffer. According to one embodiment, media capture and playback module 218 is responsive to a microphone (not particularly denoted), which provides media capture and playback module 218 with raw audio data in, e.g., pulse code modulated (PCM) format. The media capture module 218 receives the media content in a transmit buffer (302) segmented in either two or four portions, wherein each portion represents a single audio packet.

According to one embodiment, when control logic 202 of MSM 200 detects that the media input device (e.g., microphone) is active and enabled (e.g., by a host collaboration tool), control logic 202 invokes an instance of filter module 214. As introduced above, filter module 214 filters out spurious background noise that might otherwise be captured by the media input device, block 604. According to one example implementation, described more fully in FIG. 8, filter module 214 establishes an input threshold and filters noise that fails to exceed the threshold from being introduced into the media streaming and distribution channel, thereby reducing the overall noise within the collaboration environment.

In block 606, the captured media content is compressed in substantially real-time into a format employed by the host collaboration tool. According to one example implementation, introduced above, media capture and playback module 218 may well use any of a number of media CODEC's in support of the host collaboration tool. According to one example implementation, where the captured media content is audio content, media capture and playback module 218 compresses the audio content into an MP3 format, introduced above.

In block 608, control logic 202 invokes an instance of packet engine 212 to create packets of media content for transmission to remote MSM's 200. In this regard, as introduced above, packet engine 212 encapsulates the compressed media content within a network packet including source station and channel identification information, as well as network header information. As above, the assembled packet is transmitted across one or more network(s) comprising the collaboration environment to select target collaboration participants using any of a number of network protocols (e.g., the User Datagram Protocol (UDP), the real-time streaming protocol (RTSP), or the Transmission Control Protocol (TCP)), block 610. The process of FIG. 6 repeats, as necessary, until the collaboration session is completed.

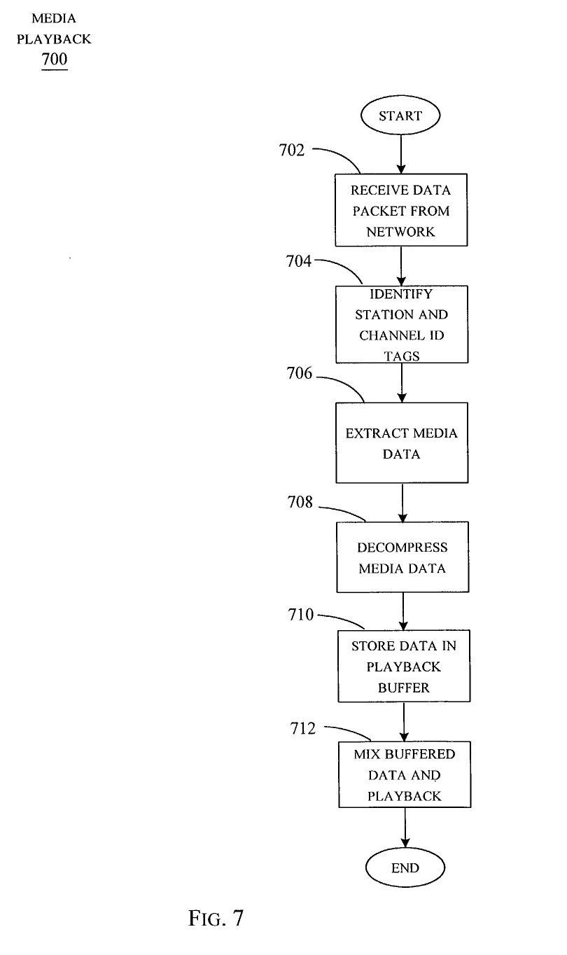

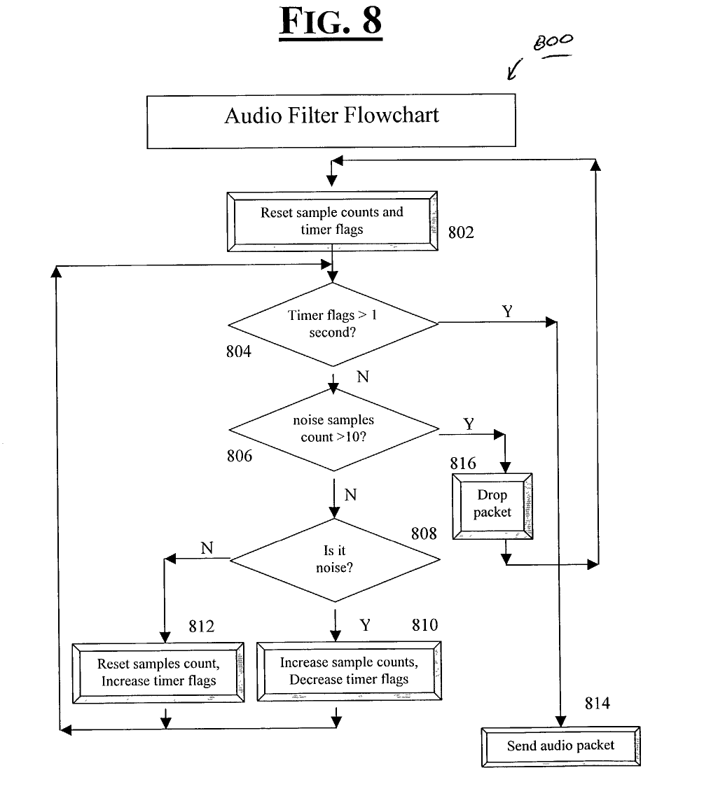

FIG. 7 is a flowchart of an example method for media playback according to one embodiment of the invention. In accordance with the illustrated example embodiment of FIG. 7, the method 700 begins with block 702 when MSM 200 receives data packets from a remote collaboration participant at media capture and playback module 218. Media capture and playback module 218 analyze information contained within the packet to identify source and/or channel identification information, block 704.

In block 706, media capture and playback module 218 extracts the media payload from the received packet, and decompresses the media content using an appropriate CODEC (e.g., MP3), block 708. Based, at least in part on the source and/or channel identification information, media capture and playback module 218 stores the recovered media content in an appropriate playback buffer, block 710. That is, media capture and playback module 218 stores the media content in a playback buffer associated with the source of the received data packet.

In block 712, control logic 202 invokes an instance of the mixer module 216, which mixes content from receive buffers associated with an active media channel for rendering by a media output device. The process of FIG. 7 continues while there is content in the receive buffers 304.

According to one aspect of an embodiment of the invention, MSM 200 includes a media filter that helps reduce the overall amount of noise introduced into the electronic collaboration environment. An example method of operation of such a filter is introduced with reference to FIG. 8.

FIG. 8 is a flowchart of an example method for media filtering according to one embodiment of the invention. As shown, the method 800 begins with block 802 where filter module 214 resets a sample count and timer flags. In block 804, filter module 214 receives content from a media input source (e.g., a microphone) and makes an initial determination of whether the time flags exceed some threshold, e.g., 1 second. If so, and filter module has not yet concluded that the media content received in such samples is noise, concludes that the content is collaboration content and sends to the samples to media capture and playback module 218 for processing in accordance with the method of FIG. 6.

If, in block 804 the timer flags have not yet reached a threshold, filter module 214 determines whether a noise sample threshold, e.g., ten (10) noise samples, have been obtained. If so, filter module 214 drops the packet as mere noise, block 816, and the process continues with block 802.

If, in block 806, the noise sample count has not reached a threshold, filter module 214 will determine whether the instant sample is noise. As used herein, filter module 214 determines whether the samples exceed a content threshold. According to one example implementation, e.g., where the media content is audio content, filter 214 determines whether the noise samples exceed one or more amplitude thresholds within a period of time to determine whether the sample represents noise. According to one implementation, exceeding the amplitude threshold(s) in a given period of time is an indication that the samples include collaboration content. In an alternate embodiment, e.g., where the media content represents video content, filter 214 performs a sum of absolute difference (SAD) analysis on frames of the sample to determine whether the content represents noise. According to one implementation, a SAD that exceeds a certain threshold is an indication that the samples represent noise.

If, in block 808, filter module determines that the sample is noise, filter module 214 increases the noise sample count, and decreases the timer flags, block 810, before the process continues with block 804.

If, in block 808, filter module determines that the sample is not noise, filter module resets the noise sample count, while increasing the timer flag, block 812, before the process continues with block 804.

According to one example implementation, filter module 214 determines that the samples represent noise if the samples fail to meet a content threshold. According to one implementation, wherein the samples contain audio content, filter module 214 concludes that the samples represent noise content is if the samples fail to meet an average amplitude. In a video environment, filter module 214 determines that the received content is noise if the sum of absolute differences (SAD) exceeds some threshold, denoting too much activity between subsequent frames to be valid content.

If, in block 806, filter module 214 determines that the received samples represent noise, filter module 214 increases the timer flags, block 808. If the samples do not represent noise, the timer flags are reset, and the filter module 214 attempts to attain more samples, block 810.

If, in block 804, more than ten (10) samples are checked, filter module 214 determines whether the timer flags are greater exceed a threshold, e.g., greater than one (1) second, block 812. If not, the samples represent non-noise audio content and the samples are sent to media capture and playback module 218 for processing in accordance with the method of FIG. 6. If, however, the time flags exceed the threshold, the process returns to block 802 as more samples are checked.

FIG. 9 is a graphical illustration of an electronic classroom collaboration environment incorporating the teachings of an embodiment of the invention. As shown in FIG. 9, an electronic classroom collaboration environment 900 is presented comprising a teacher station 902 and a plurality of student station(s) 904-908, each coupled as shown. In accordance with the teachings of the present invention, each of the stations 902-908 are endowed with an instance of the MSM 200, to support multiple media streaming and distribution channels between select participants.

Indeed, in accordance with the illustrated example implementation, three (3) disparate groups of student stations have been established, under the direction of the teacher station 902. In particular, group 1 consisting of student stations 904A . . . N, group 2 consisting of student stations 906A . . . M and group 3 consisting of student stations 908A . . . O. According to one embodiment, the teacher station 902 will only be active in one of the three groups at any given point in time. The student stations within each group can communicate with each other, as well as the teacher station if it is active within the group, using a dedicated media streaming and distribution channel, as described above. In this regard, the students of each of the groups can communicate among themselves, but cannot communicate with students active in other groups.

By dynamically controlling the grouping of the student stations 904-908, and the establishment of multiple, independent media streaming and distribution channels, the teacher station 902 enhanced with MSM 200 has a heretofore unavailable level of control over the collaboration environment.

Example Computing Appliance Architecture

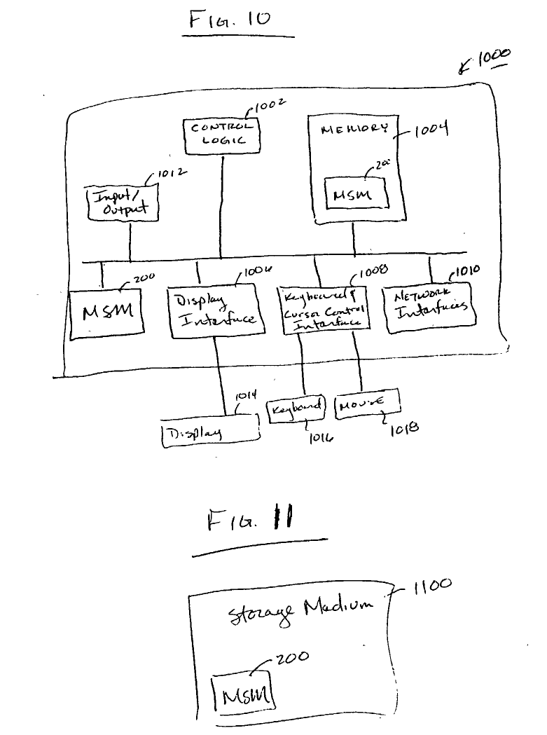

FIG. 10 illustrates a block diagram of an example computing appliance architecture incorporating alternate embodiments of the present invention. In accordance with the illustrated example embodiment of FIG. 10, computing appliance 1000 is presented comprising control logic 1002, memory 1004 with an example software implementation of MSM 200, a display interface 1006, keyboard and cursor control interface 1008, one or more network interface(s) 1010, input/output means 1012, a display device 1014, a keyboard 1016 and a mouse 1018, each logically coupled as depicted. According to one example implementation, computing appliance 1000 depicts a hardware representation of MSM 200 coupled with one or more of the system buses of the computing appliance.

As used herein, computing appliance 1000 is intended to represent any of a wide range of electronic devices known in the art such as, e.g., a computer system, personal digital assistant (PDA), wired or wireless communication device (e.g., cell phone) and the like. Moreover, computing appliances of greater or lesser complexity that nonetheless incorporate one or more aspects of media streaming module 200 as a result of the teachings herein and, as such, are anticipated within the scope and spirit of the present invention.

As used herein, each of the elements 1002-1014 of computing appliance 1000 are intended to represent such elements as they are commonly known in the art. That is, but for their interface with the innovative aspects of MSM 200 in support of an enhanced electronic collaboration environment, elements 1002-1014 represent standard elements and, as such, need not be discussed further.

Alternate Embodiment(s)

FIG. 11 illustrates a block diagram of an example storage medium comprising a plurality of executable instructions which, when implemented by an accessing computing system, implements the media streaming module in accordance with the teachings of the present invention.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps. The steps of the present invention may be performed by hardware components, such as those shown in FIGS. 1, 2 or 10, or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

What is claimed is:

1. A method comprising:
establishing a first media streaming and distribution channel in an electronic collaboration environment among a first group participants; and
establishing a second media streaming and distribution channel in the electronic collaboration environment among a second group of participants, wherein at least a manager of the electronic collaboration environment is a member of each of the first and the second group of participants.

2. A method according to claim 1, wherein the manager is only active in one group to which it is a member at a time.

3. A method according to claim 1, wherein the electronic collaboration environment is an electronic classroom.

4. A method according to claim 1, wherein the first communication channel is a broadcast channel, while the second communication channel is a full-duplex multicast channel.

5. A method according to claim 1, the elements of establishing comprising:
identifying one or more electronic collaboration environment participants for a grouping;
determining media streaming and distribution channel operating parameter(s) for the grouping; and
informing participant(s) of the grouping, and providing the participants with the operating parameters associated with the media streaming and distribution channel.

6. A method according to claim 5, wherein the manager establishes the participant groupings for the electronic collaboration environment.

7. A method according to claim 5, wherein the operating parameters include one or more of a channel identifier, participant identifier(s), duplex identifier(s), and media processing settings for the channel.

8. A method according to claim 1, further comprising:
receiving a request from a participant to establish a separate grouping with one or more other participants; and
selectively establishing the separate grouping.

9. A method according to claim 8, the establishing the separate grouping comprising:
determining media streaming and distribution channel operating parameter(s) for the grouping; and
informing participant(s) of the grouping, and providing the participants with the operating parameters associated with the media streaming and distribution channel.

10. A method according to claim 1, wherein the media streaming and distribution channel communicates audio between participants of the group.

11. A method according to claim 10, wherein communicated audio content is in an MP3 format.

12. A method according to claim 1, further comprising:
facilitating substantially real-time distribution of media content between participants in a group, the media content representing at least each participant's audio participation in the collaboration environment.

13. A method according to claim 12, the facilitating element comprising:
capturing raw data at a computing appliance associated with a group participant;
selectively processing the captured data;
encapsulating the processed data to form a media packet for distribution to other participants of the group, the media packet including a channel identifier, a source identifier and the processed media data.

14. A method according to claim 13, selectively processing comprising:
filtering out data identified as noise; and
compressing the filtered data in accordance with a compression/decompression (CODEC) employed by the electronic collaboration environment.

15. A method according to claim 14, the filtering element comprising:
excluding data in which an amplitude characteristic fails to exceed one or more thresholds during a period of time.

16. A method comprising:
receiving operating parameters for media streaming and distribution channels for each of a plurality of established groups of participants in an electronic collaboration environment, each group having at least one dedicated media streaming and distribution channel;
establishing receive buffer(s) associated with each other participant on each media streaming and distribution channel for which operating parameters are received; and
receiving an indication denoting which of the plurality of groups of the electronic collaboration environment a participant is currently assigned, enabling the participant to communicate with other members of the group via the electronic collaboration environment.

17. A method according to claim 16, wherein the operating parameters and the indication are provided by a collaboration manager of the electronic collaboration environment.

18. A method according to claim 16, further comprising:
participating in the electronic collaboration environment using the media streaming and distribution channel of the group to which the participant is currently assigned.

19. A method according to claim 18, the participating element comprising:
capturing raw data at a computing appliance associated with a group participant;
selectively processing the captured data;
encapsulating the processed data to form a media packet for distribution to other participants of the group, the media packet including a channel identifier, a source identifier and the processed media data.

20. A method according to claim 19, further comprising:
transmitting the media packet on the media streaming and distribution channel, the media packet not specifically denoting an individual target of the media packet.

21. A method according to claim 18, the participating element comprising:
receiving data packets via the media streaming and distribution channel;
analyzing at least a subset of the received packets to identify at least a source of each packet; and
storing the received packets in a buffer associated with the source of the packet for processing and rendering for the participant.

22. A method according to claim 21, further comprising:
retrieving a media packet from the buffer associated with the source of the packet;
processing the retrieved packet to produce a media content of the received packet; and
mixing the media content with other content from other group participants in the electronic collaboration environment for rendering to the participant.

23. An apparatus comprising:
a storage medium including executable content; and
control logic, coupled with the storage medium, to execute at least a subset of the executable content to implement a media streaming module to establish and control multiple media streaming and distribution channels between the apparatus and select other apparatuses in an electronic collaboration environment.

24. An apparatus according to claim 23, the media streaming module comprising:
a media capture and playback module, to receive media content captured by the apparatus for processing and transmission to participants in a group of the electronic collaboration environment in which the apparatus is currently assigned.

25. An apparatus according to claim 24, further comprising:
a filter module, responsive to the media capture and playback module, to selectively sample a subset of received media content to determine whether the sample represents noise.

26. An apparatus according to claim 25, wherein the filter module identifies the sample as noise if the media content of the sample fails to exceed one or more thresholds during a sample period.

27. An apparatus according to claim 24, further comprising:
a packet engine, responsive to the media capture and playback module, to encapsulate the received media content in a media packet for transmission to participants assigned to a common media streaming and distribution channel, the media packet including at least a source identifier and the processed media content.

28. An apparatus according to claim 23, the media streaming module comprising:
a media capture and playback module, to receive media packets from the electronic collaboration environment on a media streaming and distribution channel associated with a group to which the apparatus is currently assigned, to process the media packet to extract media content for rendering to a user of the apparatus.

29. An apparatus according to claim 28, further comprising:
a mixer module, responsive to the media capture and playback module, to receive extracted media associated with each of a plurality of participants in the group to which the apparatus is currently assigned, and to mix the extracted media for rendering to the user of the apparatus.

30. A storage medium comprising machine executable content which, when executed by an accessing machine, causes the machine to implement a media streaming module to establish and control multiple media streaming and distribution channels between the executing machine and select other apparatuses in an electronic collaboration environment.

31. A storage medium according to claim 30, the media streaming module content including content to implement a media capture and playback module, to receive media content captured by the executing machine for processing and transmission to participants in a group of the electronic collaboration environment in which the executing machine is currently assigned.

32. A storage medium according to claim 31, the media streaming module content including content to implement a filter module, responsive to the media capture and playback module, to selectively sample a subset of received media content to determine whether the sample represents noise.

33. A storage medium according to claim 32, wherein the filter module content causes the executing machine to identify the sample as noise if the media content of the sample fails to exceed one or more thresholds during a sample period.

34. A storage medium according to claim 31, the media streaming module content including content to implement a packet engine, responsive to the media capture and playback module, to encapsulate the received media content in a media packet for transmission to participants assigned to a common media streaming and distribution channel, the media packet including at least a source identifier and the processed media content.

35. A storage medium according to claim 30, the media streaming module content including content to implement a media capture and playback module, to receive media packets from the electronic collaboration environment on a media streaming and distribution channel associated with a group to which the executing machine is currently assigned, to process the media packet to extract media content for rendering to a user of the executing machine.

36. A storage medium according to claim 30, the media streaming module content including content to implement a mixer module, responsive to the media capture and playback module, to receive extracted media associated with each of a plurality of participants in the group to which the executing machine is currently assigned, and to mix the extracted media for rendering to the user of the executing machine.
